(19) United States
(12) Patent Application Publication
(10) Pub. No.: US 2014/0013100 A1
(43) Pub. Date: Jan. 9, 2014

(54) ESTABLISH BIDIRECTIONAL WIRELESS COMMUNICATION BETWEEN ELECTRONIC DEVICES USING VISUAL CODES

(71) Applicants: Martin M. Menzel, San Jose, CA (US); Anil K. Kandangath, Santa Clara, CA (US)

(72) Inventors: Martin M. Menzel, San Jose, CA (US); Anil K. Kandangath, Santa Clara, CA (US)

(21) Appl. No.: 13/542,505

(22) Filed: Jul. 5, 2012

(51) Int. Cl. H04W 4/16; H04L 9/00

(52) U.S. Cl. 713/150; 455/414.1

(57) ABSTRACT

Methods, systems, and computer readable media relating to techniques for forming network connections between electronic devices using visual codes are described. Various configurations make use of one of many possible techniques for encoding data into a visual image. A first device which receives indication of intent to establish a data connection with a second device, can display an image containing encoded data. A second device can capture the image with an attached camera and decode the image to obtain connection information for the first device. The first device can then create a data connection with the second device using the information obtained from the image.

### BACKGROUND

Wireless communication between electronic devices has been in common use and several technologies exist to enable that functionality. Electronic devices may access one another in a limited area via stationary Wi-Fi access points, or may attain access over a wider area via a cellular data network connection to the internet. Electronic devices may also be connected directly without accessing an intermediate network. Device to device communication via Bluetooth has been common for some time, and direct Wi-Fi and near field communication are also becoming a common usage model.

Creating direct device to device relationships enables numerous use cases. Users may connect devices and share files or contact information, conduct secure chat sessions, or conduct head to head gaming sessions. However, connecting directly to another electronic device carries numerous complications and security risks however. If device relationships can be created too easily, it is possible for unauthorized individuals to establish wireless connections to personal computing devices and access confidential personal or financial information. If it is too difficult to establish such connections, then the technology will not be convenient to use.

Existing methods for establishing communication between devices rely on parameters such as relative geographic location between devices, or time parameters such as the time between each device receiving an input to request a connection. A possible shortcoming of such methods includes the accidental establishment of a connection between devices. Additionally, Bluetooth can utilize several well known methods of pairing devices using pre-set or dynamic PIN validation. However, PIN based methods vary in their speed and ease of use, and can be inconvenient due to the user input which may be required to use such method.

### SUMMARY

Embodiments related to techniques for forming secure bidirectional wireless communication between electronic devices using visual codes are described herein. Various configurations make use of one of many possible visual codes (such as an image, barcodes, qr codes, series of numbers, or other unique identification codes) to uniquely identify a nearby device by using a camera, and then automatically connect to it using wireless technology. In numerous embodiments of the invention, devices intended to communicate will each, on their own display devices, display an image containing information that can be used to connect to that particular device. Other devices can capture that image with their camera and establish a data connection using the information encoded within the image.

Additionally, the images are not limited, in one embodiment, to static images using a specifically defined code sequence, but multiple embodiments can use multiple possible visual code techniques that can be dynamically determined based on, for example, the availability of one or more networks or network resources. As well, the data exchanged via visual code can be bidirectional, meaning device information can be exchanged both ways between devices, rather than unidirectionally, as is typical when transmitting information to a device via a visual code.

In at least one embodiment of the invention, the process is managed by a dedicated server with which the devices can communicate over a secure channel. In this embodiment, a user of a device can indicate intent to connect to another device via, amongst other methods, a voice command, an input gesture, or some other method of indicating the intent to connect to another device.

In other embodiments of the invention, the devices can communicate without a server. This would be advantageous in the event the devices do not have access to a network or a network of networks, such as the internet, and, in some instances, can be faster than a server based method if the connection to a network or the internet is not a high speed connection. However, this embodiment may prevent the use of additional server managed features such as obtaining connection statistics, or blocking services for particular devices from a central maintenance point.

Other features of the present invention will be apparent from the accompanying drawings and from the detailed description which follows. The above summary does not include an exhaustive list of all aspects of the present invention. It is contemplated that the invention includes all systems and methods that can be practiced from all suitable combinations of the various aspects summarized above, and also those disclosed in the Detailed Description below.

### BRIEF DESCRIPTION OF THE DRAWINGS

Embodiments of the invention are illustrated by way of example, and not limitation, in the figures of the accompanying drawings in which like references indicate similar elements.

FIG. 1 shows a flow diagram illustrating a method, in one embodiment, of establishing bi-directional communication between devices.

FIG. 2 shows a high level diagram illustrating some of the components of a hand held device capable of capturing and displaying images used to establish bi-directional communication between devices.

FIG. 3 shows an example of a low level diagram that illustrates some of the components of a hand held device.

FIG. 4 shows an example of a low level diagram illustrating a data processing system general purpose computer capable of acting to facilitate communication between devices.

FIG. 5A-5D illustrates an example of a networked infrastructure for establishing bi-direction communication between devices.

FIG. 6A-6C illustrates various possible configurations of an established bi-directional data link between devices.

FIG. 7 illustrates a low level diagram illustrating a data processing system capable of capturing and displaying images used to establish bi-directional communication between devices.

FIG. 8 shows an example of a device to device connection between a mobile device and a desktop computer with an attached webcam.

FIG. 9 shows an example of a mobile device to mobile device connection facilitated by a desktop computer with an attached webcam.

FIG. 10 is a flow diagram that shows and embodiment of a method according to one embedment of the invention.

FIG. 11 is a flow diagram that shows a method according to an embodiment of the invention

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present invention.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment. The processes depicted in the figures that follow can be performed by processing logic that comprises hardware (e.g. circuitry, dedicated logic, etc.), software, or a combination of both. Although the processes are described below in terms of some sequential operations, it should be appreciated that some of the operations described may be performed in a different order. Moreover, some operations may be performed in parallel rather than sequentially.

Unless specifically stated otherwise, throughout the description discussions utilizing terms such as “processing” or “determining” or “displaying” or the like, refer to the action and processes of a electronic computing device or similar data processing system that manipulates and transforms data represented as physical (electronic) quantities within the computer system's registers and memories into other data similarly represented as physical quantities within the computer system memories or registers or other such information storage, transmission or display devices.

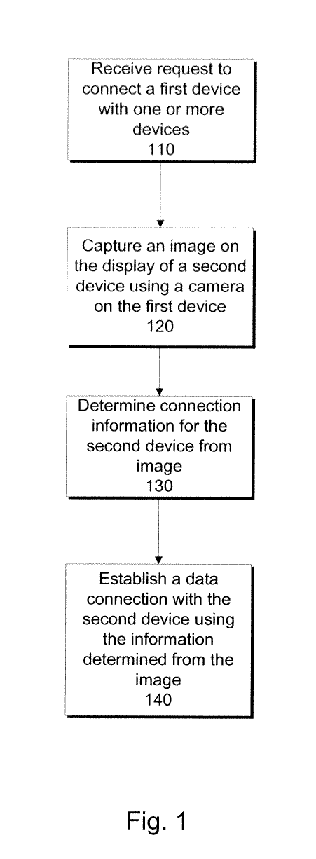

Embodiments of the invention employ a method of establishing bi-directional communication between devices by employing visual codes. FIG. 1 shows a flow diagram illustrating one embodiment of such a method. An embodiment of the method 100 begins with an operation 110 that includes receiving a request to connect a first device to one or more devices. The input request can come in numerous forms. Devices in various embodiments can receive requests via a button or an icon on a device, a touch gesture, a voice command, or any other input signifying intent to connect. Various embodiments can require each device that receives an input request to perform a second operation 120 and capture, in response to its input, an image displayed on the display of the other device using a camera in the device.

For example, a first device can receive a request to connect to a second device, and the second device can, at about the same time, receive a request to connect to the first device. In response to the request received at the first device, the first device can display connection information on a display of the first device and can concurrently capture an image of connection information displayed on the display of the second device, and at about the same time, the second device can, in response to the request received at the second device, display connection information on a display of the second device and can concurrently capture the image of connection information displayed on the first device's display. In one embodiment, each device can prompt the user of the device to point the respective device's camera toward the display of the other device; in one embodiment, each device can also confirm whether it has successfully captured the connection information from the other device.

In one embodiment, each device can have a tablet form-factor or an iphone-like form-factor and can include a camera and display screen on the same side of the tablet form-factor such that a user can point the device's display at the other device's display and both devices can concurrently display their connection information and also capture the other device's connection information; in this embodiment, each device can also include another camera on the other side opposite the display screen so that each device can be used as a standard camera to take photographs. In the case where a device has only one camera on the side opposite of the device's display, a user can be prompted to turn the display screen to face the other device's camera and be prompted to turn the camera to face the other device's display screen.

In one embodiment the device has a camera on the display side of the device, as well as a camera on the side opposite of the device's display. In this case, when a device is displaying connection information, it can also capture an image of the user of the device with the camera on the side opposite of the device's display. During the connection process, the device can display the image of the user along with the device connection data. Alternatively, the device can encode the image of the user in the connection data, or encode a network location from which to retrieve the image of the user, in the device connection data. The image of the user can then be used to identify and accept connections when there are multiple users associated with a device, or multiple devices attempting to establish a connection.

An additional operation 130 determines connection information from the captured image. Operation 130 can be performed independently at each of the first and second devices in one embodiment. The image can be used to encode connection information such as, but not limited to network address, available wireless connection methods, preferred wireless connection method, etc. In one embodiment, the image on each device can be dynamically determined based on, for example, network availability and/or security related information. Additional security related information such as a time stamp, the current geographic location of the device, an image of the user of the device, or encryption keys can also be transmitted, along with unique device identifiers such as a mobile phone number, device serial number, MAC address, or other some unique identifier can also be sent from the first device to the second device. In one embodiment, the images can be encrypted.

Once the image is analyzed to determine the necessary network, or other connection information, an additional operation 140 can be conducted, which includes establishing a data connection with the second device using information determined from the image. In one embodiment, each of the first and the second devices will perform an operation 140 in order to establish a data communication which will normally be bidirectional. Multiple connection methods may be employed depending on the available technology. Embodiments can use a local Wi-Fi network to communicate, or can use a cellular radio network to connect, or can use the Internet, or can use a combination of such networks. Embodiments can also communicate via a direct device to device connection using technologies such as Near Field Communication, Bluetooth, Direct Wi-Fi or an Ad-Hoc wireless connection. If encryption is desired, the devices may encode encryption key information to use when establishing the data connection.

The present invention can relate to an apparatus for performing one or more of the operations described herein. This apparatus may be specially constructed for the required purposes, or it may comprise a general purpose computer selectively activated or reconfigured by a computer program stored in the computer. It will be apparent from this description that aspects of the present invention may be embodied, at least in part, in software. That is, the techniques may be carried out by an apparatus in a data processing system in response to a processor executing a sequence of instructions contained in volatile or non-volatile memory, or a combination of such memories which together may embody a non-transitory machine readable storage medium.

Non-transitory machine readable storage medium comprises any type of machine readable storage medium, including floppy disks, flash memory devices, optical disks, CD-ROMs, and magnetic-optical disks, read-only memories (ROMs), random access memories (RAMs), erasable programmable ROMs (EPROMs), electrically erasable programmable ROMs (EEPROMs), magnetic or optical cards, or any type of media suitable for storing electronic instructions, as opposed to media specifically designed or designated for carrying transitory, propagating signals. In various embodiments, software-instructions stored on a machine-readable storage medium can be used in combination with hardwired circuitry to implement the present invention. Thus the techniques are not limited to any specific combination of hardware circuitry and software or to any particular source for the instructions executed by the data processing system associated an apparatus for performing one or more of the operations described herein.

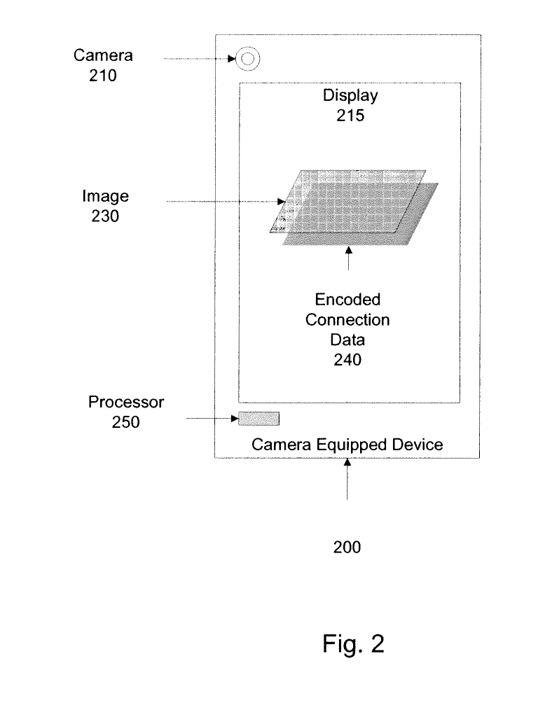

FIG. 2 illustrates a diagram of a mobile device which may implement embodiments of the method above. A camera equipped device 200 can include a camera 210 which can be used to capture an image shown on the display device of a second similarly equipped device. A device 200 can also use an embedded display device 215 to show an image 230 that can be captured by a second similarly configured device. The image 230 contains encoded connection data 240 which, when analyzed by a second device, provides information which allows the second device to connect with the first device. The data encoded in the image 240 is encoded in a manner where a machine can analyze the image and decode the information. At least a portion of the encoded connection data 240 may additionally be human readable. A processor system 250 of device 200 is used to analyze the image captured by camera 210, much in the same way the second device will use a processing system to analyze an image 230 displayed on the display device 215 of device 200.

In the embodiment shown in FIG. 2, device 200 has a display 215 and a camera 210 on the same side of the device 200 which can have a tablet or iPhone-like form-factor. In addition to the camera 215, the device 200 can also have a camera on the side opposite of the display device 215, which can capture an image of the user of the device while displaying an image 230 on the display device 215. The image of the user of the device can be displayed in conjunction with, or encoded into the image 230 that contains encoded connection data 240. In one embodiment, a confirmation prompt to the user of the device 200 can include, along with other information, an image of the user of the second device.

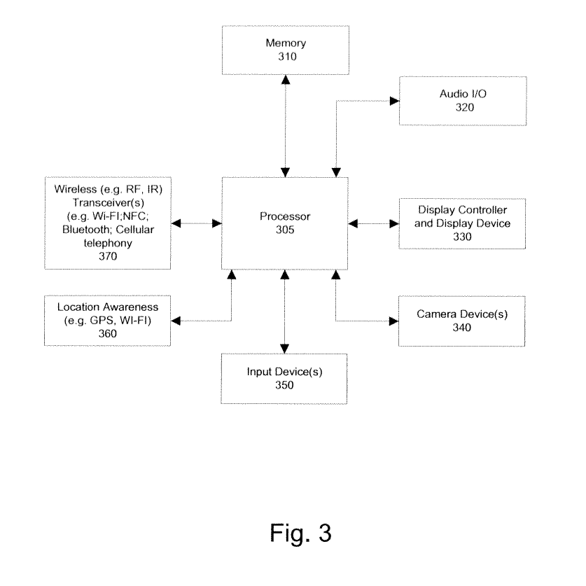

A handheld device that can implement embodiments of the invention can be represented as a data processing system with components similar to those illustrated in FIG. 3. The data processing system 300 shown in FIG. 3 includes a processing system 305 which can be an integrated circuit, such as a system-on-a-chip integrated circuit. The system 300 also includes memory 310 for storing data and programs for execution by the processing system. The system 300 additionally includes an audio input/output subsystem 320 which may include a microphone and a speaker for playing back music or providing telephone functionality through the speaker and microphone.

A display controller and display device 330 provide a visual user interface for the user; this digital interface may include a graphical user interface which is similar to that shown on, for example, the iphone (or iPod Touch, iPad, or the like, all provided by Apple Inc. of Cupertino, Calif.), though embodiments are envisioned that can operate on other devices or data processing systems. The display device and display controller system 330 may comprise one or more display device technologies such as an LCD or LED display. The display controller may communicate with the display device via one or more interfaces utilizing, for example, LVDS or MIPI-DSI technologies. In addition to providing a user interface, the system 300 can use a display device 330 to display a visual image which contains connection information that can allow a second, similarly configured data processing system, to form a data connection with the system 300. This data connection may be via one or more connectivity devices, such as a wireless transceiver 370. The wireless transceiver 370 can transmit and receive data via one or more wireless technologies such as Wi-Fi, infrared, Bluetooth, or one or more variants of wireless cellular technology.

Embodiments of system 300 can also contain one or more camera devices 340 which can be used to capture an image displayed on the display device of a data processing system configured similarly to system 300. Multiple camera devices may be included in system 300 configured in both a front and rear facing configuration, though similarly configured systems each with a front facing camera may be one of many optimal configurations.

The data processing system 300 can also include one or more input devices 350 that allow a user to provide input to the system. Input devices can include a keypad or keyboard, alone or in conjunction with a touch or multi touch panel that is overlaid on the display device 330. Additionally, embodiments of the data processing system 300 can also include a device for providing location awareness, such as a Global Positioning System (GPS) device 360 or its equivalent. Embodiments could use that information as part of the connection establishment process. For example, a device comprised of the data processing system 300 can be configured to only connect to other systems that are geographically local to them. Alternatively, devices may only connect to systems that are in a remote geographic location if it is known that the data connection is intended to be to a device known to be remote.

One or more input devices 350 can be used to allow a user to indicate the intent to connect a device represented by system 300 to another similarly configure system or device. It is to be noted that the data processing system 300 as represented in FIG. 3 is by way of example. One or more buses or interfaces, which are not shown, may be used to interconnect the various components, as is well known in the art. As well, additional components, not shown, may also be part of the system 300 in certain embodiments, and in certain embodiments fewer components than shown in FIG. 3 may also be used in a data processing system.

The methods described herein are not limited to handheld devices and can be implemented on a variety of different data processing devices, including general purpose computer systems, embedded systems, consumer electronic devices, special purpose computer systems, etc. For example, the data processing systems which may use any one of the methods described herein may include a desktop computer or a laptop computer or a tablet computer, in addition to smart phone, tablet or PDA devices. In other embodiments, the data processing system 300 may be a network computer or an embedded processing device within another device, an entertainment system (e.g., a Nintendo DS, Play Station Vita), a consumer electronic device, or other types of data processing systems which have fewer components or perhaps more components than that shown in FIG. 3.

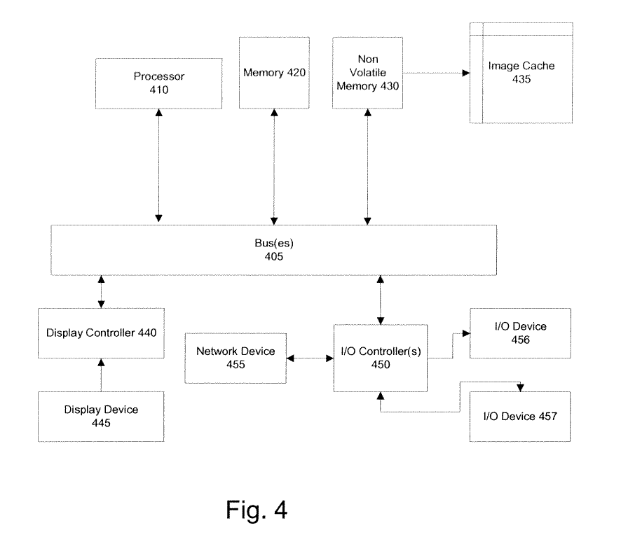

FIG. 4 shows one example of a data processing system 400 which may be used as a network server to facilitate embodiments of the present invention. Note that while FIG. 4 illustrates the various components of a data processing system, such as a computer system, it is not intended to represent any particular architecture or manner of interconnecting the components as such details are not germane to the present invention. It will also be appreciated that other types of data processing systems which have fewer components than shown or more components than shown in system 400 may also be used with the present invention, including multiple systems configured similarly to system 400 working in parallel.

As shown in FIG. 4, the data processing system 400 includes one or more buses 405 which serve to interconnect the various components of the system. One or more processors 410 are coupled to the one or more buses 405 as is known in the art. Memory 420 may be DRAM or non-volatile RAM or may be flash memory or other types of memory. This memory is coupled to the one or more buses 405 using techniques known in the art. The data processing system 400 can also include non-volatile memory 430 which may be a hard disk drive or a flash memory or a magnetic optical drive or magnetic memory or an optical drive or other types of memory systems which maintain data even after power is removed from the system. The non-volatile memory 430 and the memory 420 are both coupled to one or more buses 405 using known interfaces and connection techniques.

Non-volatile memory 430 can be configured to contain an image-cache 435 to store generated images containing encoded connection or validation information for devices whose connections the data processing system is facilitating. The image-cache 435 may be used in some embodiments to reduce the processor 410 load under certain scenarios. For example, if a device were to send repeated requests for image generation within a short period of time, the data processing system 400 can store, and subsequently retrieve the generated image instead of creating a new image for each request. Embodiments would see varying benefits from the image cache 435 based on the computational complexity of the precise image generating algorithm employed. For example, if some embodiments use advanced cryptographic techniques to encrypt the data in the image, the computation load may not scale well if the server is handling a large volume of image generation requests.

A display controller 440 is coupled to the one or more buses 405 in order to receive display data to be displayed on a display device 445 which can display a user interface to allow operation and maintenance of the system 400. The data processing system 400 can also include one or more input/output (I/O) controllers 450 which provide interfaces for one or more I/O devices, such as those represented generically by I/O Device 456 or I/O Device 457, but especially to network device 455. While FIG. 4 shows system 400 configured such that the non-volatile memory 430 and the memory 420 are coupled to the one or more buses directly rather than through a network interface such as one provided by network device 455, the data processing system 400 may utilize a non-volatile memory which is remote from the system, such as a network-attached storage (NAS) device which is coupled to the data processing system through a network interface.

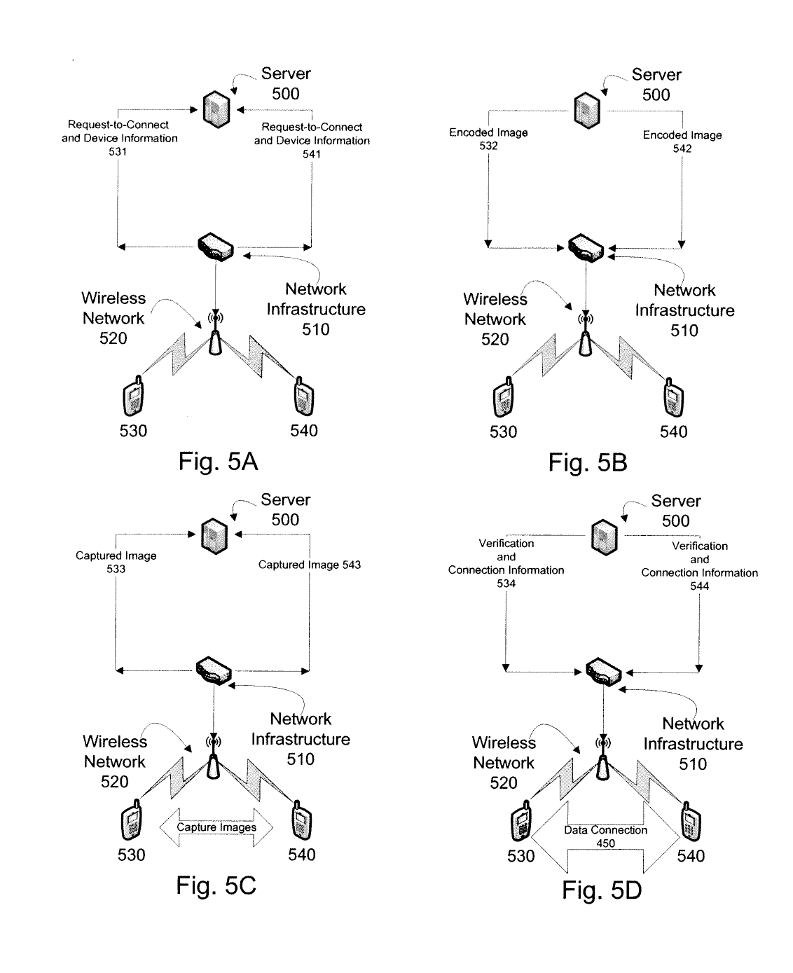

In one embodiment, a set of devices can be programmed or configured to establish a data connection through a direct peer-to-peer communication through a direct peer to peer communication mode, while in other embodiment a set of devices can be programmed or configured to establish a data connection through a server, such as server 500 in FIGS. 5A-5D, that facilitates the set up of the connection. In yet other embodiments, a set of devices can be programmed or configured to be capable of direct peer-to-peer connections and also server facilitated connections and can be programmed or configured to dynamically select or switch between the different modes.

FIGS. 5A through 5D illustrate a client-server network infrastructure which may implement embodiments of invention. This client-server network infrastructure can provide a secure connection between two or more client devices and at least one server. FIGS. 5A through 5D contain elements that are common through the figure set and are present in each figure, as well as elements that are unique to each figure, and the elements are numbered accordingly. FIG. 5A shows a server device 500 arranged in a client-server configuration over a network with multiple handheld devices. Though it should be noted that while handheld wireless devices are used by example in certain figures, embodiments of the invention are not specifically limited to such wireless devices.

FIG. 5A further shows a first wireless device 530 and a second wireless device 540 each configured to connect with a server 500 via a network composed of wired or wireless devices, or a combination of wired and wireless devices. The first device 530 will receive an input to request-to-connect with a second, potentially unspecified device. That input to request to connect can be contemporaneous with an input at device 540 to connect to a second, potentially also unspecified device. In one embodiment, the first device 530 can transmit a request-to-connect 531 via an encrypted wireless network onto a wired network infrastructure to which a server 500 is connected. The second device 540 can also transmit a request-to-connect 541 via an encrypted wireless network onto a wired network infrastructure to which server 500 is connected. Should the sever be configured to process such requests from device 530 or device 540, the server can generate a visual image containing encoded connection or connected validation information corresponding to the requesting device. That means that, in this embodiment, device 530 requests that the server generate an image for device 530 to display on its attached display device, and device 540 requests that the server generate an image for device 540 to display on its attached display device.

FIG. 5B illustrates an embodiment of the invention wherein a first encoded image 532 is sent to a first device 530 and a second encoded image 542 is sent to a second device 540. The server 500 can encode within an image information that includes, but is not limited to: network specific connection information for a device based on information known about the device available to a cellular network service provider, information provided by the device during the request to connect, information provided by the device user contemporaneously to the input of the connection request, or from some other source. The connection information in the image can, in one embodiment, be dynamically determined as explained herein.

In one embodiment, the server 500 can then send a first encoded image 532 to a first device 530 and a second encoded image 542 to a second device 540 via a network comprising a wired network infrastructure 510 alone or in conjunction with a wireless network 520. When a device has obtained an encoded visual image, such as an encoded image 532 for a device 530 or the encoded visual image 542 for device 540, it then displays the image on its display device and at the same time starts a camera associated with the device, such as one illustrated by camera device 340 of FIG. 3 or camera 210 of FIG. 2. Cameras are commonly found in modern mobile devices such as smart-phones, tablet computers, or laptops, but the invention can also be used to connect to non-mobile devices, such as connecting a smart-phone to a desktop computer that has a webcam connected, or connecting a smart-phone or other wireless mobile device to a remote wireless device using remote cameras as intermediaries.

FIG. 5C shows two devices facing each other such that they are capable of recognizing the other device's visual image. In one embodiment, the first device 530 may recognize the second device 540 as a device capable of connecting via the transfer of visual codes. This may be accomplished, for example, by scanning for and recognizing a certain pattern common to all visual images used in the connection method (e.g. a common start sequence of numbers, a particularly shaped frame around the image, color codes, etc). A first device 530 can then use its camera to capture the image on the display of a second device 540, just as any other device 540 can use its camera to capture the image on the display of another device 530. Each device, by using its camera and by reading and processing the information contained in the image using OCR (optical character recognition) or other means of image processing may conduct an image decode and validation process. Alternatively, a device can send the images to a server 500 for decode and validation. For example, in one embodiment the first device 530 will send a capture image 533 to a server 500, and a second device 540 can also send a captured image 543 to a server 500.

FIG. 5D illustrates a networked client server infrastructure wherein a server 500 decodes images sent from a first device 530 and a second device 540. The server 500 can decode the information embedded in a visual image and use that information to establish a data connection between a first device 530 and a second device 540. This data connection can be secure by using encryption established by the server 500. In this embodiment, a first set of device connection information 534 can be sent to a first device 530, and a second set of device connection information can be sent to a second device. The first device 530 and second device 540 each now have the information from other device to establish a data connection 450.

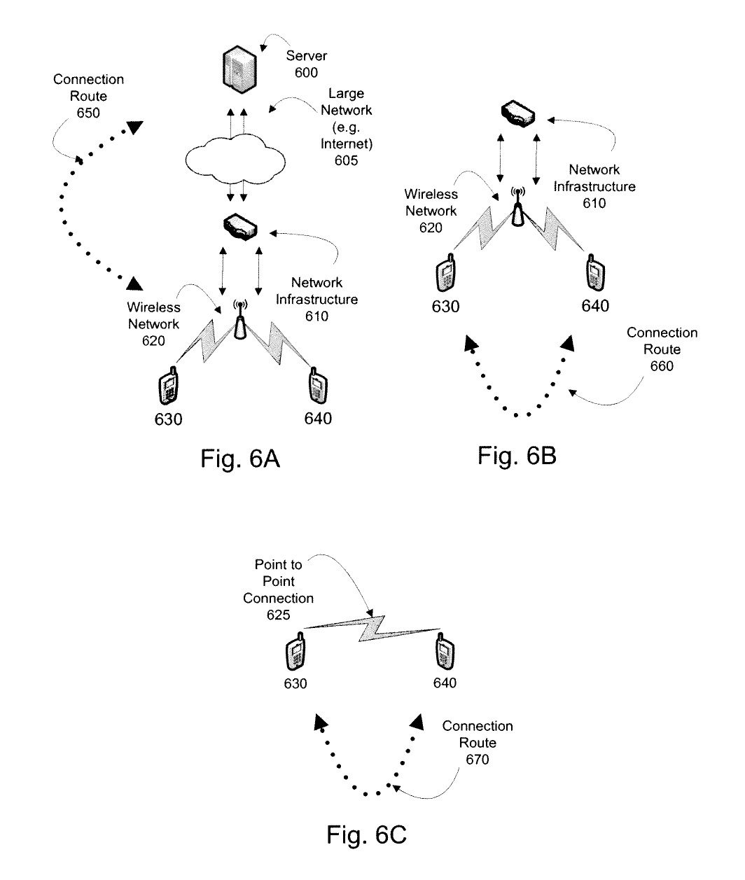

The data connection can be establishing using one or more wireless technologies such as Wi-Fi, Bluetooth, or NFC, and can be established in a direct device to device manner, or via a local network (LAN), or routed through a larger network (internet or intranet). FIGS. 6A through 6C illustrate non-limiting examples of how a data connection can be routed. One embodiment is demonstrated in FIG. 6A. A first wireless device 630, having established a data connection using with device 640, can route such a connection 650 through a server 600 via a large network (605) such as the Internet. This embodiment allows facilitated, mediated or filtered data connections between a first device and a second device using a number of algorithmic or heuristic methods. Embodiments of the invention may use this connection method to allow the first device 630 and second device 640 to participate competitively or cooperatively in an online gaming session hosted on the server 600, or allow secure and private chat sessions or data exchange sessions between the first device and second device. A data connection mediated by a server would allow a service provider to directly obtain relevant connection statistics or block services to certain devices via a central point of maintenance.

FIG. 6B illustrates a connection method between devices that is routed through a secure network infrastructure that is device mediated rather than server mediated. The connection can be established via a wireless local area network 620 or involve a wired portion of network infrastructure 610 such as private or corporate intranet network. Embodiments of the invention using the connection route 660 illustrated in FIG. 6B may also comprise gaming or chat sessions, or may comprise bi-directional burst transfer of data such as an exchange of contact information, application specific data, or social network contact information. Wireless network 620 may also be a cellular wireless network allowing devices to exchange information only between devices on that particular carrier's network.

FIG. 6C illustrates a connection established in a direct, device to device manner using technologies such as, but not limited to, Ad-hoc Wi-Fi, direct Wi-Fi, NFC, or Bluetooth. In this embodiment, a first handheld device 630 and a second handheld device 640 may establish a data connection via a connection route 670 that comprises only wireless mobile computing devices and is not establish through or facilitated by infrastructure devices. Instead, a point to point data connection 625 is established between the various connected mobile devices. Use cases using this embodiment can be the same as use cases available to connections illustrated in FIG. 6A or FIG. 6B, or may encompass additional use cases that are unique to the device to device connection route 670.

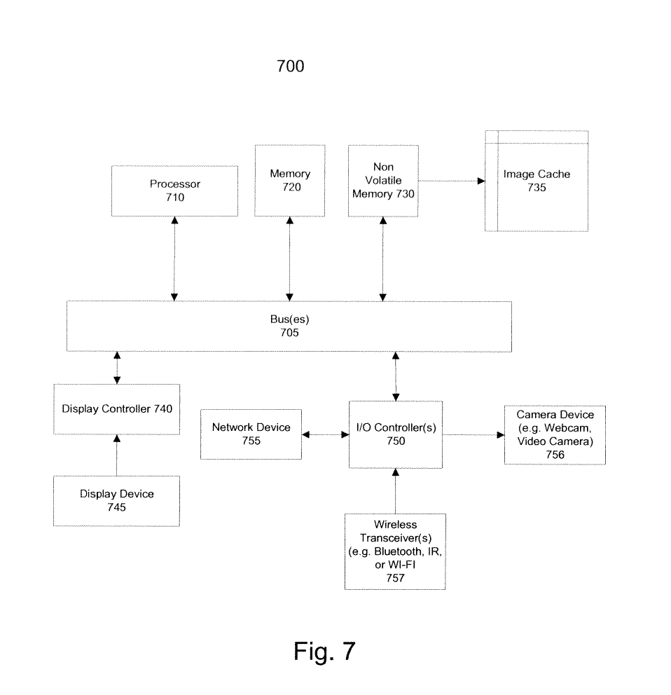

In addition to handheld or embedded devices, embodiments of the invention can be implemented by devices such as laptops or desktop computers. FIG. 7 shows a data processing system 700 that is a similar to that encompassed in a modular, general purpose computer such as a laptop or desktop computer. Note that while FIG. 7 illustrates various components of a computer system, it is not intended to represent any particular architecture or manner of interconnecting the components as such details are not germane to the present inventions. The computer system shown in FIG. 7 may, for example, be a Mac computer from Apple, Inc. or a computer which runs the Windows operating software from the Microsoft Corporation.

As shown in FIG. 7, the computer system 700 includes a bus 705 which is coupled to one or more microprocessors which form a processing system 710. The bus 705 is also coupled to memory 720 and to a non-volatile memory 730, which may be, in various embodiments, a magnetic hard drive, flash memory, battery backed volatile memory, or, in some embodiments, a combination of these devices. The non-volatile memory may house an image cache 735 which may be used to optimize the connection process by storing some number of visual images that have been generated and may be re-used. The bus 705 is also coupled to a display controller, 740 which can be attached to one or more display devices 745. The bus 705 is also attached to one or more I/O controllers 750 to which one or more I/O devices may be attached, including a wired network device 755, one or more wireless transceivers 757, and a camera device 756, which can be integrated physically into the system or housed externally and attached via a wired or wireless interface. The processing system 710 may include one or more microprocessors, such as a microprocessor from Intel or IBM. The bus 705 interconnects these various components together in a manner which is known in the art.

The memory 720 can be implemented as dynamic RAM (DRAM) which provides fast access to data but is considered “volatile” in that it requires power continually in order to refresh or maintain the data in the memory. The non-volatile memory 730 can be used for data storage and retains data even after power is removed from the system. While FIG. 7 shows that the non-volatile memory 730 is a local device coupled directly to the rest of the components in the data processing system, it is notable that other embodiments can utilize a NAS device, or some other type of remote storage which is coupled to the data processing system through a network device 755. The bus 705, as is well known in the art, may include one or more buses connected to each other through various bridges, controllers, and/or adapters as is known in the art. In one embodiment, the I/O controller 750 may include a USB adapter for controlling USB peripherals and an IEEE-1394 controller for IEEE-1394 compliant peripherals.

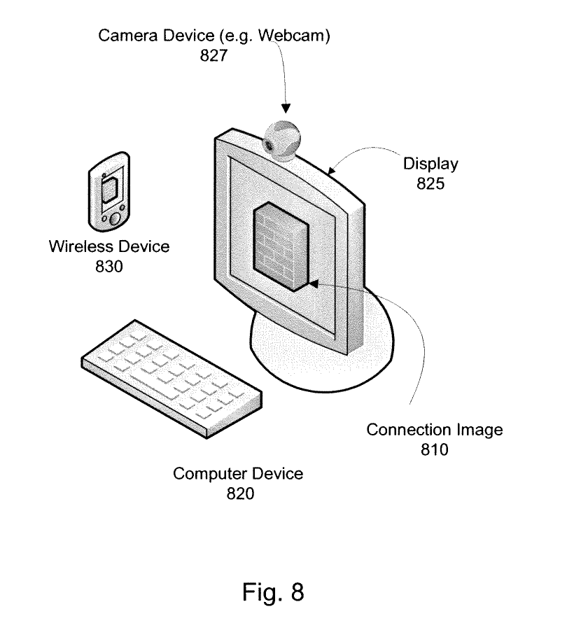

FIG. 8 shows how embodiments of the invention can be used to connect a device similar to that of FIG. 2 with a device comprising the data processing system of FIG. 7. A computer device 820, which may be a mobile or desktop computer, with a display 825 and a camera device 827, such as a webcam or video camera, can display an image containing encoded connection data 810 and capture the image displayed on the display of a wireless device 830. Embodiments of the invention can use a server based method to generate and compare images or, alternatively, the devices may perform the image generation and image decode function themselves. Additionally, the data connection, once established, may be configured in at least any of the connection routes illustrated in FIG. 6.

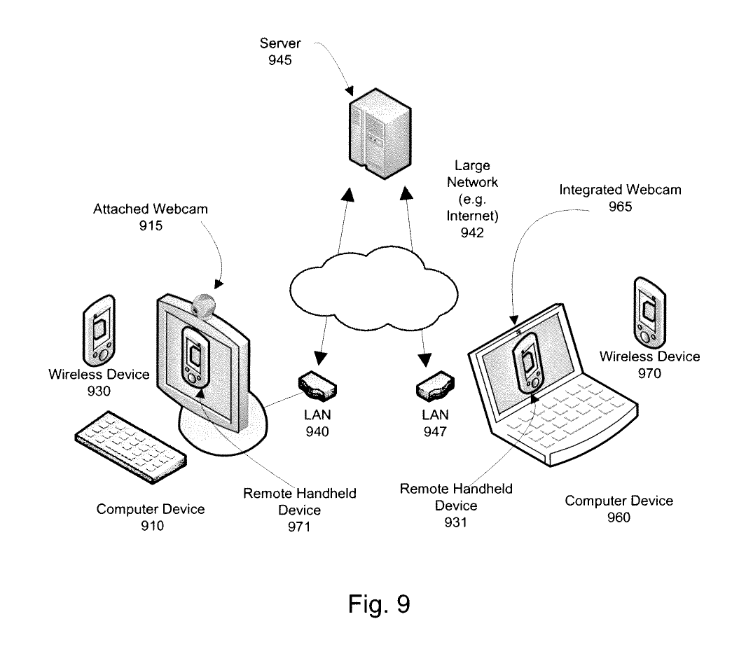

FIG. 9 illustrates an embodiment of the invention similar to that demonstrated in FIG. 8, however, in this embodiment remotely situated handheld devices may be connected using visual codes by way of camera equipped computer devices, or other camera equipped data processing devices. A first wireless handheld device 930 can display an image containing encoded connection data which can be captured by an attached webcam 915 of a first computer device 910. A second wireless device 970 can display an image containing encoded connection data which can be captured by, for example, an integrated webcam 965 of a second computer device 960. The first computer device can transmit one or more captured images over a first local area network (LAN) 940 onto a large network 942 such as, for example, the internet, just as the second computer device can transmit one or more captured images via a LAN 947 onto a large network 942. An image of the first wireless device 930 can then appear as an image of a remote handheld device 931 on the display of the second computer device 960. An image of the second wireless device 970 can also appear as an image of a remote handheld device 971 on the display of the first device.

Other embodiments can function in a manner similar to the networked client server infrastructure illustrated in FIGS. 5A through 5D, wherein a networked server device 945 can perform one or more functions of the network attached server 500 depicted in FIGS. 5A through 5D. Embodiments of the invention can have one or more functions such as encode, decode, or match performed at a networked server device, or those functions can be performed by a wireless handheld device or their computer device intermediaries.

Any one of the devices implementing embodiments of the invention may also use location awareness technology (e.g. GPS) during one or more encode, decode, or match functions. For example, a handheld device may be configured to only accept connections from devices in its geographic vicinity, or alternatively, if connecting to a remote device, accept connections from the known geographic location of the remote device. Additionally, embodiments of the invention may utilize location awareness technology to cache previously generated images for devices within a specific geographic location. In embodiments using a remote server such as the server 945 shown in FIG. 9 or the server 500 shown in FIG. 5 to implement an embodiment of the invention, the server may implement one or more additional verification steps after decoding the connection data in the image to determine if a data connection will be established between devices.

For example, when a server is configured to receive both captured images and device identifiers from devices, the server can match the two devices as a pair that intends to connect based on the unique device ids, timestamps, and optionally the geographic device location determined by location technologies like GPS, Wi-Fi, Cell technologies, IP address resolution, or other location technologies. Other embodiments may disable or tailor location awareness for use cases such as one in FIG. 9 utilizing remote cameras. Additionally, embodiments may, when creating an image containing connection information, encode a security key in the image, and require that any device attempting to establish a connection recite the appropriate security key.

Embodiments of the invention may also provide the ability for devices to establish a data connection using visual codes when a connection to a networked server is not available. This functionality is advantageous in the event the devices do not have access to internet. Embodiments using device only verification may, in some instances, perform faster verification than a server based method if the connection to the internet is not a high speed connection. However, this embodiment may prevent the use of additional server managed features such as obtaining connection statistics, or blocking services for particular devices from a central maintenance point.

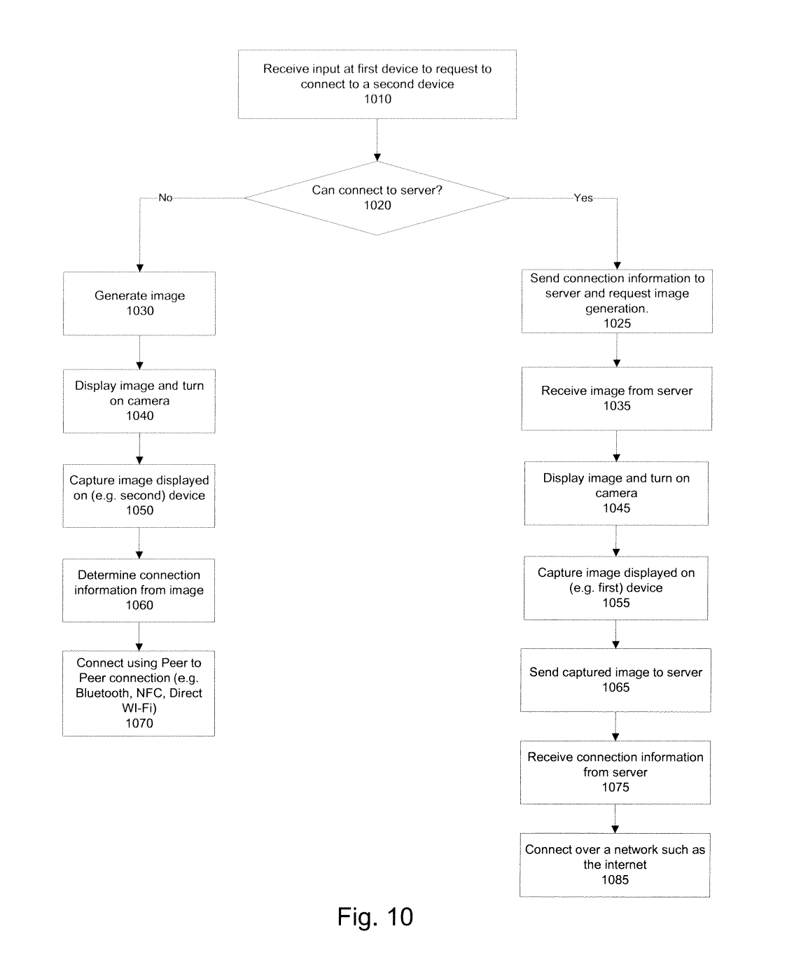

FIG. 10 illustrates two sequences of operations that one embodiment can follow depending on whether or not a device can connect to a server, such as server 500 in FIGS. 5A through 5D. Initially, an event 1010 occurs where a first device will receive an input to request that first device to connect to a second device. It is possible, also that at the same time as event 1010 a second device can receive a request to connect to a first device. The devices will each conduct a query 1020, using either specialized techniques or techniques known in the art (such as pinging known operating services at known IP addresses) to determine whether each of them can connect to a server to facilitate the connection process. If the network environment is such that, for example, the first device cannot connect to the server, the device will conduct an operation 1030 where it generates a first image using known connection data and device specific information. Subsequently the device will conduct an additional operation 1040 where it displays the generated image while enabling, in some embodiments, a front facing camera near the display.

In some embodiments, a second device, having received an input event analogous to the event 1010 received at the first device, will have, in some manner or another, generated a second image, which will be displayed on the display device of the second device. At this point the camera on the first device can be enabled, and the device can conduct an operation 1050 that allows the capture of the second image on the display of a second device. From that second image, the first device can conduct a decode event 1060 where the connection information for the second device is determined from the second image. Having obtained the information required, the first device will proceed to a connection event 1070 where the device will form, or at least initiate, in various embodiments, a Wi-Fi, Bluetooth, or NFC connection, or some other network connection with the second device. The second device can also perform operations in which it captures and image on the first device's display and uses connection information from that image to establish the data connection.

Alternatively, a device can conduct a query 1020 and find that it can connect to a server, such as the server 500 in FIGS. 5A-5D. At this point, some embodiments would have the device conduct an operation 1025 where the device would send connection information, and additionally, in one embodiment, device specific identification data to a server. It would be appreciated at this point that either the first or second device can connect with another device whether or not the one, both or neither of the devices can access the server, however, various embodiments can limit the connection type available to the devices, or limit the services available to devices that have formed a connection.

Once the device sends whatever required connection and identification information to the server, some embodiments of the invention will have the server generate and send an image for the device corresponding to transmitted information or, alternatively, will send instructions to the device on how to generate the image, which the device will do so using a variety of novel techniques, or techniques known in the art such as one of various 3D graphics or vector graphics APIs. The device will receive the image, in some form or another, from the server in a receive operation 1035, after which, the device can proceed to an operation 1045 where the device will display the image on an attached display device and turn on a camera. As in the image display operation 1040 conducted without the server, in this operation 1045, various embodiments of the invention can have, for example, the first device display a first image on an attached display device and enable an attached camera device, while the second device will display a second image on an attached display, where the second image is specific to the second device, while enabling an attached camera controlled by the second device.

Once the camera is enabled, a capture operation 1055 can capture, for example, on the second device, an image on the display of the first device, in a manner analogous to the capture operation 1050 conducted without the server, however, this embodiment would have the captured image sent to the server in operation 1065. The server would receive a message image, decode the image, and return the required connection information to the device in message 1075 containing the connection information. One embodiment of the invention, having connected to the second device using a server facilitated method, can finish the process in a connection operation 1085 where the second device will connect to the first device over at network such as, for example, the internet. Once connected over the network, the devices could conduct a number of data transactions which may or may not require facilitation from a server device similar to the device used to facilitate the connection.

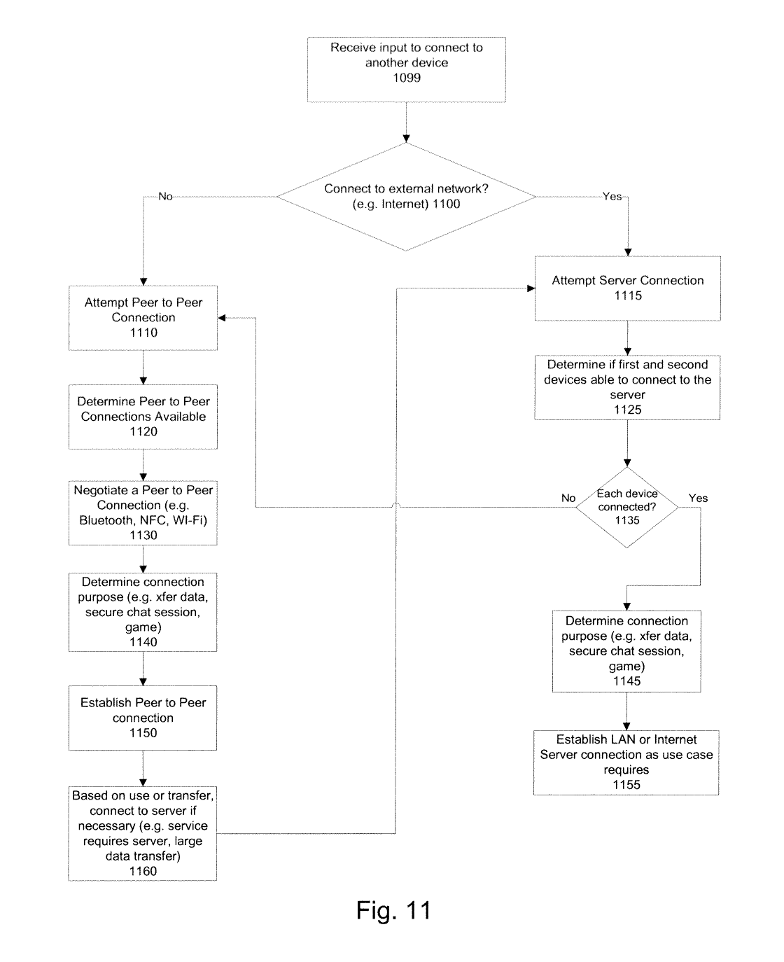

Embodiments of the invention do not limit the final data connection type to that used to create the initial data connection. The data connection type can dynamically change after the images are used to establish the connection. FIG. 11 illustrates one manner in which the data connection can be established by an embodiment of the invention once the connection is negotiated via visual images. In operation 1099, a device can receive an input requesting a connection to another device. In operation 1100, a first device can determine whether to connect to the internet to establish a data connection with a second device. Various embodiments will use various criteria to make this determination, which includes, but is not limited to, the type of service or utility the devices will use once the connection is established, the type of network connections available to the various devices at the time, or the type or amount of data to be transferred. Additionally, embodiments may switch from one data connection type to a second data connection type dynamically based on changing conditions.

To illustrate the above, a device may attempt an operation 1110 where the device can create a peer to peer connection. Embodiments can proceed to an operation 1120 where the device determines the type of peer to peer connections available. Not all devices may support all connection methods and embodiments, for example, may be limited to Wi-Fi and Bluetooth and will not be able to establish a Near Field Communication connection. Whatever connection types are common between devices are considered and negotiated by one embodiment in a negotiation operation 1130 where the devices will decide a preferred connection type. This selection can occur before, after or concurrently, in various embodiments, with operation 1140 where one or more devices will filter the available connection types based on one or more goals of the connection. For example, if a secure chat session over short range radio is desired, then a peer to peer connection would be compatible. However, if devices are to be used to play a game and the game requires an internet server, then a peer to peer connection will not suffice. Depending on the scenario the device can proceed to an operation 1150 in which a peer to peer connection is established, or, in other scenarios and other embodiments, the device can, after establishing a peer to peer connection, notify other devices in a transfer operation 1160 in which one or more devices can indicate a need to connect to the internet, through which embodiments can transfer the connection.

Alternatively, embodiments may determine in operation 1100 that the device will connect to the internet. In that case, the device will attempt a server connection operation 1115 in which the device will attempt to establish a connection to a server. The server can be a server similar to the server 600 in FIG. 6A-6C through which devices may play a common game, transfer encrypted information, or some other server facilitated operation. If a first device is able to connect to the server, and wishes to use a server connection, but a second device cannot connect to the server, then the type of operations possible over a data connection can be limited in some embodiments. Accordingly, devices in question will need to perform an operation 1125 to determine if all relevant devices are able to connect to the server. Embodiments would then, based on a conditional operation 1135 that tests if each device is connected, can then proceed to further filter the available data connection types based on connection type usage in operation 1145. However, if each device is not connected, devices can, in various embodiments, shift to an operation 1110 in which one or more devices attempt to establish a peer to peer connection and follow the sequence described previously for peer to peer connections. In some embodiments, however, the ideal scenario is one in which all devices can connect to a server, such as the server 600 in FIG. 6A-6D, or at the very least the internet. In one embodiment, this scenario would find all devices able to establish an operation 1155 wherein each device can establish a connection either over a local area network, or through an internet server.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

1. A method at a first device comprising:
receiving a first input to request the first device to establish a data connection with a second device, the second device capable of receiving a second input to request the second device to establish a data connection with the first device;
displaying, on the first device, a first image containing information to establish a data connection between the first and second device;
capturing, through a camera at the first device, a second image on a display of the second device;
determining connection information for the second device from the second image captured by the first device; and
establishing a data connection with the second device using the connection information from the second image.

2. The method of claim 1 further comprising generating the first image containing information to establish a data connection between the first device and the second device, and wherein the first device is configured to use a point to point connection.

3. The method of claim 2 wherein generating the first image occurs at the first device and wherein the first image is dynamically determined based on availability of one or more local wireless networks.

4. The method of claim 2 wherein generating the first image comprises:
retrieving connection information for the first device;
retrieving an identifier unique to the first device;
retrieving a geographic location of the first device; and
creating an encoded image containing the connection information, unique identifier and geographic location of the first device.

5. The method of claim 4 wherein generating the first image occurs at a networked server attached via a client-server infrastructure connected via one or more encrypted communication channels, and wherein the first image is encrypted with one or more keys that are provided to the second device.

6. The method of claim 4 further comprising storing and grouping the first image in an image cache based on the geographic location of the first device and retrieving the first image from the image cache.

7. The method of claim 4 wherein the encoded image additionally contains a third image of the user of the first device.

8. The method of claim 7 further comprising capturing, through a camera at the first device, a third image of the user of the first device.

9. An electronic device comprising:
a processor to receive a request to establish a data connection with a second device, the second device capable of receiving a second input to request the second device to establish a data connection with the first device;
a display coupled with the processor to display a first image containing information to establish a data connection with a first device, wherein the first image is dynamically determined based on availability of one or more local wireless networks; and
a camera coupled with the processor and the display, the camera to capture a second image on a display of the second device, wherein the processor determines the information required to establish the data connection with the second device from the second image captured by the camera, and establishes the data connection between the first and second device.

10. The device of claim 9 further comprising a location awareness device to provide a geographic location for the device.

11. The device of claim 9 further comprising one or more wireless transceivers to enable wireless data connectivity.

12. The device of claim 9 further comprising a second camera coupled with the processor, to capture a third image of the user of the device.

13. A machine-readable storage medium having instructions stored therein, which when executed by a machine, cause a machine to perform operations for establishing data connections between devices, the operations comprising:
receiving an input to request a first device to establish a data connection with a second device, the second device capable of receiving a second input to request the second device to establish a data connection with the first device;
displaying, on the first device, a first image containing information to establish a data connection between the first and second device;
capturing, through a camera at the first device, a second image on a display of the second device;
determining connection information from the second image; and
establishing the data connection with the second device using the connection information from the second image.

14. The machine-readable storage medium of claim 13 further comprising creating an image that contains information used to establish a data connection.

15. The machine-readable storage medium of claim 13 wherein the data connection established is negotiated amongst a plurality of wireless technologies.

16. The machine-readable storage medium of claim 13 wherein the data connection established is via a secure wireless network infrastructure.

17. The machine-readable storage medium of claim 13 wherein the data connection established is via a direct device to device wireless connection.

18. The machine-readable storage medium of claim 13 further comprising displaying, on the first device, an image associated with the user of the second device.

19. The machine-readable storage medium of claim 18 further comprising capturing, through a camera at the first device, an image of the user of the first device.

20. A secure client-server infrastructure to establish a data connection between devices comprising:
a first device capable of establishing a point to point or server facilitated connection with a second device, the first device to display and capture an image;
a second device capable of establishing a point to point or server facilitated connection with a first device, the second device to display and capture an image; and
a secure server with which the first and second devices communicate over an encrypted communication channel, the secure server to
receive in conjunction with a first device identifier associated with the first device, a request to connect the first device to the second device,
receive in conjunction with a second device identifier associated with the second device, a request to connect the second device to the first device,
create an image for the first device and send the image to the first device, wherein the first image is dynamically determined based on availability of one or more local wireless networks, and wherein the first image is encrypted with one or more keys that are provided to the second device,
create an image for the second device and send the image to the second device, wherein the second image is dynamically determined based on availability of one or more local wireless networks, and wherein the first image is encrypted with one or more keys that are provided to the second device,
receive, from each device, a request to decode images captured by a camera of each device,
decode the image captured by each device and send connection information to each device, and
establish a data connection between the first device and second device.

21. The secure client-server infrastructure of claim 20 wherein the secure server which the first and second devices communicate further comprises an image cache to optimize image creation.

22. The secure client-server infrastructure of claim 20 wherein the data connection established between the first device and the second device is chosen from a plurality of wireless technologies.

23. The secure client-server infrastructure of claim 20, wherein the data connection established between the first device and the second device is via a secure wireless infrastructure.

24. The secure client-server infrastructure of claim 20, wherein the data connection between the first device and the second device is via a direct device to device wireless connection.

25. The method of claim 1, further comprising:
at the second device,
receiving the second input to request the second device to establish a data connection with a first device;
displaying the second image containing information to establish a data connection between the second device and the first device;
capturing, through a camera at the second device, the first image on a display of the first device;
determining connection information for the first device from the first image captured by the second device; and
establishing a data connection with the first device using the connection information from the first image.
